(19) United States
(12) Patent Application Publication
(10) Pub. No.: US 2019/0354562 A1
(43) Pub. Date: Nov. 21, 2019

(54) User Association Method, Terminal, and Server

(71) Applicant: Huawei Technologies Co., Ltd., Shenzhen (CN)

(72) Inventor: Yuanli Gan, Shenzhen (CN)

(21) Appl. No.: 16/347,141

(22) PCT Filed: Nov. 3, 2016
(86) PCT No.: PCT/CN2016/104404

§ 371 Date: May 2, 2019

(51) Int. Cl. G06F 16/9535; G06F 16/906

(52) U.S. Cl. CPC G06F 16/9535; H04L 51/32; G06F 16/906

(57) ABSTRACT

A user association method, terminal, and server, where the method includes receiving, by a first application server, an account of a first user from a first terminal, obtaining associated activity information of the first user and a second user from a second application server based on the account of the first user, where the associated activity information includes user information of the second user, determining, based on the associated activity information, whether the first user and the second user are associated users, and sending the user information of the second user to the first terminal when the first user and the second user are associated users such that the first terminal displays the user information of the second user on a screen of a first application.

### TECHNICAL FIELD

The present invention relates to the field of social networking, and in particular, to a user association method, terminal, and server.

### BACKGROUND

With rapid development of social networking, people spend more time communicating with friends on the Internet and expect to know more like-minded friends through the Internet. Therefore, to meet people's social requirements, it is necessary to accurately recommend friends to users.

According to a prior-art technical solution of friend recommendation, a friend is usually recommended to a user by automatically importing contacts in a contact list or based on a quantity of shared friends.

The manner of recommending a friend to a user by automatically importing contacts in a contact list is limited to mobile phones, and is difficult to use widely in social networking. A friend recommended to the user based on the quantity of shared friends belongs to a second-level friend circle. Therefore, accuracy of the recommendation is limited.

### SUMMARY

This specification describes a user association method, terminal, and server, to make a friend recommendation in a current application by determining whether a current user and another user are associated users, to expand a source of the friend recommendation and improve accuracy of the friend recommendation.

According to a first aspect, an embodiment of the present invention provides a user association method that is performed by a first application server. The method includes: receiving, by the first application server, an account of a first user that is sent by a first terminal; obtaining, by the first application server, associated activity information of the first user and a second user from a second application server based on the account of the first user, where the associated activity information includes user information of the second user; determining, by the first application server based on the associated activity information, whether the first user and the second user are associated users; and sending, by the first application server, the user information of the second user to the first terminal if the first user and the second user are associated users, so that the first terminal displays the user information of the second user on a friend recommendation screen of a first application.

In the user association method provided in this embodiment of the present invention, associated activity information of a current user of the first application and another user in another application is analyzed, and the another user of interest to the current user is recommended as a potential friend to the current user, thereby expanding a range of friend recommendation and improving accuracy of the friend recommendation.

With reference to the first aspect, in a first possible implementation of the first aspect, the associated activity information further includes user source information of the second user; and the method further includes: sending, by the first application server, the user source information to the first terminal, so that the first terminal displays the user source information on the friend recommendation screen of the first application.

In this embodiment of the present invention, displaying source information of a potential friend makes it convenient for the user to manage the potential friend and other friends.

With reference to the first possible implementation of the first aspect, in a second possible implementation of the first aspect, the method further includes: receiving, by the first application server, an operation instruction of the first user that is sent by the first terminal and that is used for adding the second user to a user list; creating, by the first application server, at least one user group in the user list based on the user source information; and adding, by the first application server, second users belonging to same user source information into a same user group.

In this embodiment of the present invention, adding friends with a same source into a same user group makes it convenient for the user to manage the friends.

With reference to the first aspect, in a third possible implementation of the first aspect, the associated activity information further includes attribute information of associated activities performed by the first user and the second user; and before the sending, by the first application server, the user information of the second user to the first terminal, the method further includes: sorting, by the first application server, display priorities for the second user based on the attribute information; and sending, by the first application server, a display priority sorting result of the second user to the first terminal, so that the first terminal displays the display priority sorting result of the second user on the friend recommendation screen of the first application.

In this embodiment of the present invention, displaying and sorting recommended potential friends based on attribute information of associated activities make it convenient for the user to add a most interested potential friend as a friend.

With reference to the first possible implementation of the first aspect, in a fourth possible implementation of the first aspect, the method further includes: receiving, by the first application server, an operation instruction that is sent by the first terminal and that is used for obtaining a second-user source category tab; creating, by the first application server, a second-user source category tab on the friend recommendation screen of the first application based on the user source information; sending, by the first application server, the second-user source category tab to the first terminal, so that the first terminal adds second users belonging to a same user source category into a same second-user source category tab.

In this embodiment of the present invention, a tab is created based on a source category of a potential friend, and potential friends belonging to a same source category are added into a same tab, thereby making it convenient for the user to manage the potential friends.

With reference to the fourth possible implementation of the first aspect, in a fifth possible implementation of the first aspect, the method further includes: sorting, by the first application server, priority display for the second-user source category tab based on a quantity of second users included in the second-user source category tab; and sending, by the first application server, a priority display sorting result of the second-user source category tab to the first terminal, so that the first terminal displays the priority display sorting result of the second-user source category tab on the friend recommendation screen of the first application.

In this embodiment of the present invention, sequentially displaying tabs based on quantities of potential friends in the tabs makes it convenient for the user to manage the potential friends.

With reference to the first aspect, in a sixth possible implementation of the first aspect, the method further includes: receiving, by the first application server, information about an operation instruction of the first user that is sent by the first terminal and that is used for creating a customized tab; creating, by the first application server based on the information about the operation instruction for creating a customized tab, a tab customized by the first user; and sending, by the first application server, the tab customized by the first user to the first terminal, so that the first terminal adds a second user that meets a customized condition of the first user into the tab customized by the first user.

In this embodiment of the present invention, the user may create a customized tab, and a potential friend meeting a condition defined by the user may enter the customized tab, thereby making it convenient for the user to manage the potential friend.

With reference to the second possible implementation of the first aspect, in a seventh possible implementation of the first aspect, the method further includes: receiving, by the first application server, information about an operation instruction of the first user that is sent by the first terminal and that is used for creating a customized friend group; creating, by the first application server, a customized friend group in the user list based on the information about the operation instruction for creating a customized friend group; and sending, by the first application server, the customized friend group to the first terminal, so that the first terminal adds a second user that meets a customized condition of the first user into the customized friend group.

In this embodiment of the present invention, the user may customize a friend group, and a friend meeting a customized condition of the user may enter the customized group, thereby making it convenient for the user to manage the friend.

According to a second aspect, an embodiment of the present invention provides a user association server. The server includes: a receiving unit, configured to receive an account of a first user that is sent by a first terminal; an obtaining unit, configured to obtain associated activity information of the first user and a second user from a second application server based on the account of the first user, where the associated activity information includes user information of the second user; a processing unit, configured to determine, based on the associated activity information, whether the first user and the second user are associated users; and a sending unit, configured to send the user information of the second user to the first terminal if the first user and the second user are associated users, so that the first terminal displays the user information of the second user on a friend recommendation screen of a first application.

According to a third aspect, an embodiment of the present invention further provides a user association server. The server includes: an interface circuit, configured to: receive an account of a first user that is sent by a first terminal, and obtain associated activity information of the first user and a second user from a second application server based on the account of the first user, where the associated activity information includes user information of the second user; and a processor, configured to determine, based on the associated activity information, whether the first user and the second user are associated users, where the interface circuit is further configured to send the user information of the second user to the first terminal if the first user and the second user are associated users, so that the first terminal displays the user information of the second user on a friend recommendation screen of a first application.

According to a fourth aspect, an embodiment of the present invention provides a user association method that is performed by a first terminal. The method includes: obtaining, by the first terminal based on an account of a first user, associated activity information of the first user and a second user from a second terminal, where the associated activity information includes user information of the second user; determining, by the first terminal based on the associated activity information, whether the first user and the second user are associated users; and displaying, by the first terminal, the user information of the second user on a friend recommendation screen of a first application if the first user and the second user are associated users.

According to a fifth aspect, an embodiment of the present invention provides a user association terminal. The terminal includes: an obtaining unit, configured to obtain, based on an account of a first user, associated activity information of the first user and a second user from a terminal on which a second application is located, where the associated activity information includes user information of the second user; a processing unit, configured to determine, based on the associated activity information, whether the first user and the second user are associated users; and a display unit, configured to display the user information of the second user on a friend recommendation screen of the first user if the first user and the second user are associated users.

According to a sixth aspect, an embodiment of the present invention further provides a user association terminal. The terminal includes an RF circuit, a processor, a memory, and a display screen.

According to the user association method, terminal, and server provided in the embodiments of the present invention, associated activity information of a current user of the first application and another user in another application is analyzed, and the another user of interest to the current user is recommended as a potential friend to the current user, thereby expanding a range of friend recommendation and improving accuracy of the friend recommendation.

### BRIEF DESCRIPTION OF DRAWINGS

To describe the technical solutions in the embodiments of the present invention or in the prior art more clearly, the following briefly describes the accompanying drawings required for describing the embodiments or the prior art.

FIG. 1 is a schematic diagram of a system architecture to which a user association method performed by a first application server is applied according to an embodiment of the present invention;

FIG. 2 is a schematic diagram of a system architecture to which a user association method performed by a first terminal is applied according to an embodiment of the present invention;

FIG. 3 is a schematic diagram of another system architecture to which a user association method performed by a first terminal is applied according to an embodiment of the present invention;

FIG. 4 is a flowchart of a user association method that is performed by a first application server according to an embodiment of the present invention;

FIG. 5 is a flowchart of a user association method that is performed by a first terminal according to an embodiment of the present invention;

FIG. 6a and FIG. 6b are a schematic diagram of a recommendation result of a user association method according to an embodiment of the present invention;

FIG. 7a and FIG. 7b are a schematic diagram of another recommendation result of a user association method according to an embodiment of the present invention;

FIG. 8 is a schematic structural diagram of a first application server according to an embodiment of the present invention;

FIG. 9 is a schematic diagram of a hardware structure of a first application server according to an embodiment of the present invention;

FIG. 10 is a schematic structural diagram of a first terminal according to an embodiment of the present invention; and

FIG. 11 is a schematic diagram of a hardware structure of a first terminal according to an embodiment of the present invention.

### DESCRIPTION OF EMBODIMENTS

The following describes the technical solutions in embodiments of the present invention with reference to the accompanying drawings. Apparently, the described embodiments are merely some but not all of the embodiments of the present invention.

The ordinal numbers such as “first” and “second” mentioned in the embodiments of the present invention shall only serve the purpose of differentiation unless the numbers definitely indicate a sequence according to the context.

Nowadays, there are many types of social applications. To conveniently manage a plurality of social applications, a user can log in to different applications with one account, and communicate with other users or engage in related activities in different social applications. Among these users, there may be a user of interest to the user and with whom the user wants to make friends in another application. In a user association method according to the embodiments of the present invention, a user is associated with another user of interest to the user in a current application based on communication information or an association of common activities between the user and the another user in another application, and then the another user may be recommended as a friend.

An application scenario of the user association method according to the embodiments of the present invention is specifically described as follows by using a first user and a second user as an example:

The first user and the second user are users of a first application and are also users of a second application. A first application account of the first user and a second application account of the first user may be a same cloud account. For example, a QQ account is shared on WeChat and QQ. Alternatively, the first application account of the first user and the second application account of the first user may be associated accounts. The associated accounts may be a first application account that is authorized to log in to the second application, or a second application account that is authorized to log in to the first application. For example, an Alipay account may be authorized to log in to Taobao. Alternatively, the associated accounts may be accounts that are of different applications and that have or include same information, to indicate that the accounts of the different applications are used by a same user. Specifically, the associated accounts may be accounts that are of different applications and that are indicated by a same user name, a same email address, a same mobile number, or the like. Alternatively, the associated accounts may be accounts that are of different applications and that are associated with a same user name, a same email address, a same mobile number, a same bank account, or the like.

Referring to the description of the accounts of the first user, a first application account of the second user and a second application account of the second user may be a same cloud account, or may be associated accounts.

In the following, a first terminal is a terminal on which the first application is installed and runs, a second terminal is a terminal on which the second application is installed and runs, a first application server is a server corresponding to the first application, and a second application server is a server corresponding to the second application.

In the second application, the first user and the second user perform associated activities, for example, like, reply to, or comment on same or similar topics in a forum of the second application, chat by mentioning each other with @ in a social group chat, chat privately, respective contact lists, purchase same or similar products or services, perform similar activities, or the like. The associated activities all may imply that the first user and the second user are interested in each other. A basic idea of the user association method according to the embodiments of the present invention is as follows: A user account is associated with the foregoing associated activity information. After the first user logs in to the first application, the first application server or the first terminal may perform user association by using the associated activity information. Specifically, the first application server or the first terminal may obtain the foregoing associated activity information from the second application server or the second terminal by using a cloud account shared by the first application and the second application of the first user or by using the second application account that is of the first user and that is obtained by using information shared by associated accounts, and perform determining; if the associated activity information meets a preset condition, determine that the first user is interested in the second user and the first user and the second user are associated users; and then recommend the second user as a potential friend of the first user in the first application.

It should be understood that the associated activity information records the second application account of the first user and the second application account of the second user, and the first application server may obtain the associated activity information from the second application server by using the cloud account shared by the first application and the second application of the first user or the associated accounts. Because the second user is also a user of the first application, and the second application account and the first application account of the second user are a same cloud account or associated accounts, the first application server or the terminal on which the first application is located may use the second user as a user of the first application, associate the second user with the first user in the first application, and then make a friend recommendation.

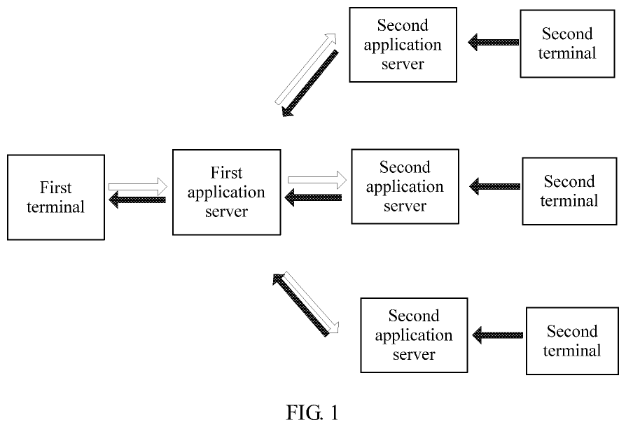

The following describes a system architecture to which a user association method performed by a first application server is applied according to an embodiment of the present invention. As shown in FIG. 1, the system includes a first terminal, the first application server, a second terminal, and a second application server. A first application and a second application may run on a same terminal. In other words, the first terminal and the second terminal may be a same terminal. The first terminal and the second terminal may include a smartphone, a tablet computer, a laptop computer, a computer, a wearable device, and the like.

It should be noted that the first application server and the second application server may obtain activity information of a shared user, or the first application server first sends an information obtaining request to the second application server, and then obtains information stored in the second application server with approval of the second application server.

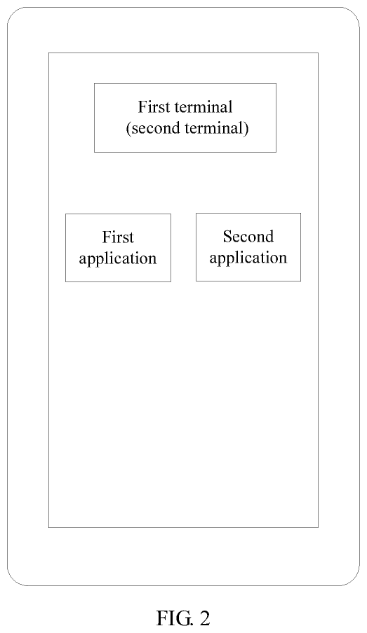

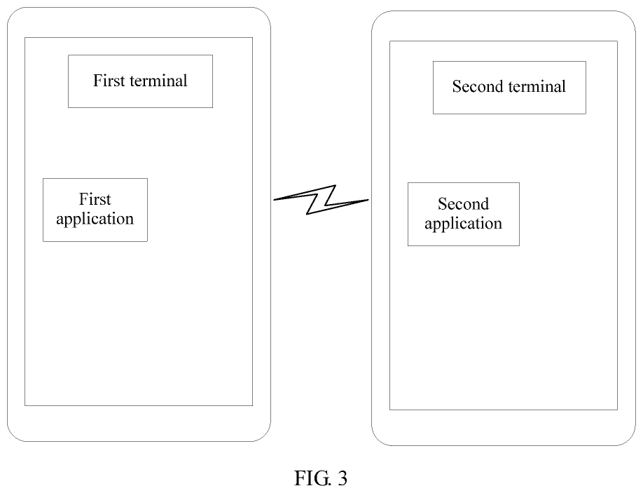

The following describes a system architecture to which a user association method performed by a first terminal is applied according to an embodiment of the present invention. As shown in FIG. 2, a first application and a second application may be installed on a same terminal. In other words, the first terminal and a second terminal are a same terminal. Activity information of a first user in the second application may be stored in the terminal. The first application may obtain associated activity information of the first user and a second user directly from the terminal or from the activity information that is of the second application and that is stored in the terminal. As shown in FIG. 3, the first terminal and the second terminal may be different terminals. The first terminal may obtain the activity information of the first user in the second application from the second terminal in a communication manner such as Bluetooth or Wi-Fi, and then obtain the associated activity information of the first user and the second user; or may directly obtain the associated activity information from the second terminal. The terminal may include a smartphone, a tablet computer, a laptop computer, a computer, a wearable device, and the like.

The first application may be an application with a friend system, for example, WeChat, a microblog, Taobao, a contact list or an address book provided by the terminal, Facebook Chat, or WhatsApp, and more specifically, may be an application with a friend system under a Samsung account or an Apple account. There may be a plurality of second applications, and the second application may be an application with a friend system described above. A person of ordinary skill in the art should understand that the first application and the second application are two different types of applications, but both may be applications with a friend system. Alternatively, the second application may be a payment application, for example, Apple Pay (Apple Pay); a health application, for example, MyFitnessPal; a game application, for example, Warcraft (Warcraft); a shopping application, for example, Amazon (Amazon), or the like. A first application of a user may share a cloud account with a second application; or a user may log in to a second application by using a first application account authorized by the user; or a user may log in to a first application by using a second application account authorized by the user; or a user may log in to a second application by using a second application account that is an account associated with a first application account. The user association method according to the embodiments of the present invention may associate users being interested in each other, thereby implementing friend recommendation with a wide source and high accuracy.

The first user performs associated activities with the second user in the second application. The associated activity information of the first user records the associated activities, and further includes an account of the first user, an account of the second user, account information of the second user, and the like. The second application server stores the associated activity information. The second terminal may also store the associated activity information. When the first user logs in to the first application by using the account of the first user, the first application server may obtain the associated activity information from the second application server by using the cloud account shared by the first application and the second application or associated accounts, or the first terminal may obtain the associated activity information from the second terminal. Then the associated activity information is analyzed. When the associated activity information meets a specified condition, it may be considered that the first user and the second user are interested in each other and the first user and the second user are associated with each other. Therefore, the second user is recommended to the first user in the first application.

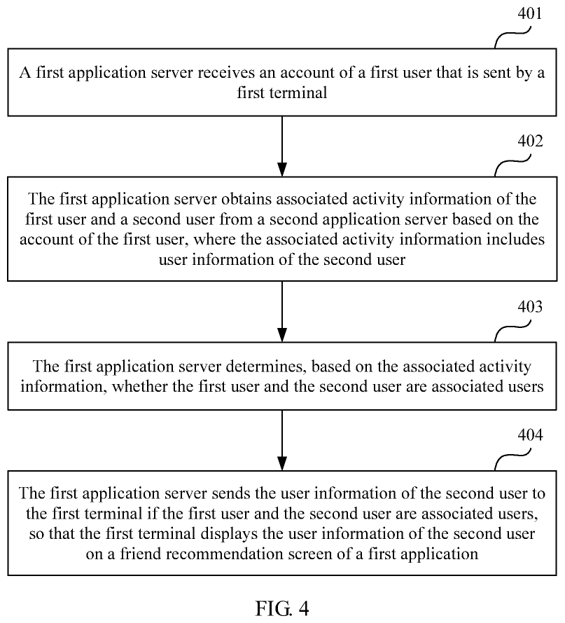

An embodiment of the present invention provides a user association method. The method is performed by a first application server. The method is specifically described with reference to FIG. 4.

Step 401. The first application server receives an account of a first user that is sent by a first terminal.

The first terminal is a terminal on which a first application is located. The account of the first user may be a cloud account shared by the first application and a second application, or may be a first application account associated with a second application account. The first user may enter the account into a login screen of the first application installed on the first terminal, to log in to the first application. The first terminal may send the account to the first application server after obtaining the account.

Step 402. The first application server obtains associated activity information of the first user and a second user from a second application server based on the account of the first user, where the associated activity information includes user information of the second user.

As described above, the account of the first user may be a cloud account shared by the first application and the second application. In this case, the first application server may obtain the associated activity information of the first user and the second user from the second application server based on the first application account.

Alternatively, the account of the first user may be the first application account associated with the second application account. In this case, the first application server may obtain the second application account based on information shared by the associated first application account and second application account, and further obtain the associated activity information.

If the first application and the second application belong to a same service provider, the first application server obtains the associated activity information from the second application server based on the account of the first user. If the first application and the second application separately belong to different service providers, the first application server may obtain the associated activity information of the first user and the second user from the second application server based on the first application account of the first user by using a protocol between the first application and the second application.

The associated activity information of the first user and the second user is information about associated activities that are of the first user and the second user and that occur in the second application. The associated activities of the first user and the second user are activities that are performed by the first user and the second user in the second application and that have an association. For example, the first user and the second user like, reply to, or comment on same or similar topics in a forum of the second application, chat by mentioning each other with @ in a social group chat, chat privately, respective contact lists, purchase same or similar products or services, perform similar activities, or the like. More specifically, assuming that the second application is a payment application, the associated activities include payment records for, for example, payment between the first user and the second user, or payment between each of the first user and the second user and a third user. Further, assuming that the second application is a health application, the associated activities include doing similar sports at similar time, or the like. Further, assuming that the second application is a game application, and the first user and the second user play a same game and have similar rankings, the associated activities include same or similar time periods for playing the game. Assuming that the second application is a shopping application, the associated activities include purchasing similar products in a same time period, or the like. In short, the first user and the second user perform related activities, or perform related activities at associated places and time. The activities imply that the first user and the second user may be interested in each other, and the activities may be referred to as associated activities.

The associated activity information of the first user and the second user records the associated activities that are of the first user and the second user and that occur in the second application, further includes a second application account of the first user, a second application account of the second user, the user information of the second user, and the like, and is stored in the second application server. Because the account of the first user may be a cloud account shared by the first application and the second application, or may be the first application account associated with the second application account, the first application server may obtain information about the associated activities from the second application server based on the account of the first user.

Step 403. The first application server determines, based on the associated activity information, whether the first user and the second user are associated users.

The first application server analyzes the obtained associated activity information, to determine whether the associated activity information meets a preset condition. Specifically, it is analyzed whether the likes, replies, comments, or the like of the same or similar topics exceed preset frequency. It is analyzed whether frequency and duration of chatting by mentioning each other with @ in the social group chat, chatting privately, or the like exceed a preset value. The respective contact lists are analyzed to determine whether a quantity of common contacts or a quantity of contact times meets a preset value. It is analyzed whether comments or proportions for purchasing the same or similar products, services, or the like exceed a preset value. It is analyzed whether frequency, duration, or the like for performing the similar activities or the like exceeds a preset value. More specifically, assuming that the second application is a payment application, a payment record or the like is analyzed. Further, assuming that the second application is a health application, time, a place, or the like of the sports is analyzed. Further, assuming that the second application is a game application, a game type, game time, or the like is analyzed. If an analysis result meets the specified condition, it may be considered that the first user and the second user are associated users.

Step 404. The first application server sends the user information of the second user to the first terminal if the first user and the second user are associated users, so that the first terminal displays the user information of the second user on a friend recommendation screen of a first application.

That the first user and the second user are associated users indicates that the first user is interested in the second user and intends to make friends with the second user. Therefore, the first application server sends information about the second user to the first terminal, so that the first terminal displays the user information of the second user on the friend recommendation screen of the first application.

The second application account of the second user may be a cloud account shared by the first application and the second application. In this case, with the cloud account, the second user may be a user of the first application. Alternatively, the second application account of the second user may be an account associated with the first application account of the second user. In this case, the first application account of the second user may be obtained based on information shared by the second application account and the first application account of the second user. In this way, the second user may be recommended as a potential friend to the first user in the first application.

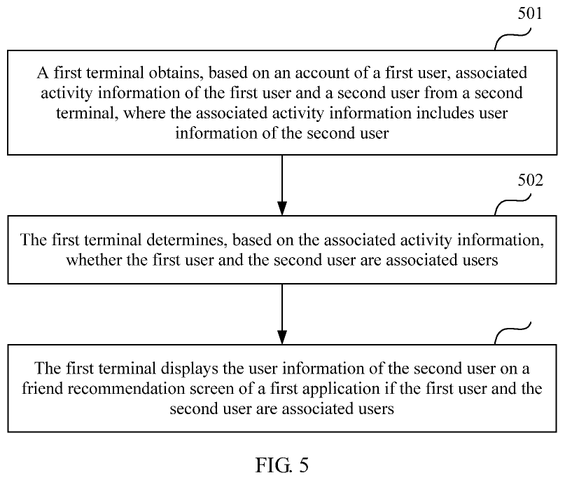

An embodiment of the present invention further provides a user association method that is performed by a first terminal. The method is specifically described with reference to FIG. 5.

Step 501. The first terminal obtains, based on an account of a first user, associated activity information of the first user and a second user from a second terminal, where the associated activity information includes user information of the second user.

The first terminal and the second terminal may be a same terminal. The first terminal may obtain, from locally stored information based on the account of the first user, information about associated activities that are of the first user and the second user and that occur in a second application. Alternatively, the first terminal and the second terminal may be different terminals. The first terminal may obtain, based on the account of the first user, the associated activity information of the first user and the second user from information stored in the second terminal in a communication manner such as Wi-Fi or Bluetooth.

As described above, the account of the first user may be a cloud account shared by the first application and the second application. In this case, the first terminal may obtain the associated activity information of the first user and the second user from the second terminal based on a first application account. Alternatively, the account of the first user may be a first application account associated with a second application account. In this case, the first terminal may obtain the second application account based on information shared by the associated first application account and second application account, and further obtain the associated activity information.

The associated activity information of the first user and the second user is information about associated activities that are of the first user and the second user and that occur in the second application. The associated activities of the first user and the second user are activities that are performed by the first user and the second user in the second application and that have an association. For example, the first user and the second user like, reply to, or comment on same or similar topics in a forum of the second application, chat by mentioning each other with @ in a social group chat, chat privately, respective contact lists, purchase same or similar products or services, perform similar activities, or the like. More specifically, assuming that the second application is a payment application, the associated activities include payment records for, for example, payment between the first user and the second user, or payment between each of the first user and the second user and a third user. Further, assuming that the second application is a health application, the associated activities include doing similar sports at similar time, or the like. Further, assuming that the second application is a game application, and the first user and the second user play a same game and have similar rankings, the associated activities include same or similar time periods for playing the game. Assuming that the second application is a shopping application, the associated activities include purchasing similar products in a same time period, or the like. In short, the first user and the second user perform related activities, or perform related activities at associated places and time. The activities imply that the first user and the second user may be interested in each other, and the activities may be referred to as associated activities.

The second terminal may store the associated activity information when the first user performs the associated activities. Alternatively, the second terminal may receive the associated activity information sent by a second application server, and store the associated activity information locally.

The associated activity information records the associated activities that are of the first user and the second user and that occur in the second application, and further includes a second application account of the first user, a second application account of the second user, the user information of the second user, and the like. Because the account of the first user may be a cloud account shared by the first application and the second application, or may be the first application account associated with the second application account, a terminal on which the first application is located may obtain, based on the account of the first user, the associated activity information from a terminal on which the second application is located.

Step 502. The first terminal determines, based on the associated activity information, whether the first user and the second user are associated users.

The first terminal analyzes the obtained associated activity information, to determine whether the associated activity information meets a preset condition. Specifically, it is analyzed whether the likes, replies, comments, or the like of the same or similar topics exceed preset frequency. It is analyzed whether frequency and duration of chatting by mentioning each other with @ in the social group chat, chatting privately, or the like exceed a preset value. The respective contact lists are analyzed to determine whether a quantity of common contacts or a quantity of contact times meets a preset value. It is analyzed whether comments or proportions for purchasing the same or similar products, services, or the like exceed a preset value. It is analyzed whether frequency, duration, or the like for performing the similar activities or the like exceeds a preset value. More specifically, assuming that the second application is a payment application, a payment record or the like is analyzed. Further, assuming that the second application is a health application, time, a place, or the like of the sports is analyzed. Further, assuming that the second application is a game application, a game type, game time, or the like is analyzed. If an analysis result meets the specified condition, it may be considered that the first user and the second user are associated users.

Step 503. The first terminal displays the user information of the second user on a friend recommendation screen of a first application if the first user and the second user are associated users.

That the first user and the second user are associated users indicates that the first user is interested in the second user and intends to make friends with the second user. Therefore, the first terminal displays information about the second user on the friend recommendation screen of the first application used by the first user.

The second application account of the second user may be a cloud account shared by the first application and the second application. In this case, with the cloud account, the second user may be a user of the first application. Alternatively, the second application account of the second user may be an account associated with the first application account of the second user. In this case, the first application account of the second user may be obtained based on information shared by the second application account and the first application account. In this way, the second user may be recommended as a potential friend to the first user in the first application.

Although some common social networking activities are listed above, it does not mean that an application scope of the recommendation method provided in the embodiments of the present invention is limited to the listed social networking activities. Any activities performed by the first user and the second user that can associate the first user with the second user, and any analysis of the associated activity information to determine that the associated activity information meets the specified condition are included in the scope of the present invention.

In the user association method provided in the embodiments of the present invention, associated activity information of a current user of the first application and another user in another application is analyzed, to recommend the another user of interest to the current user as a potential friend to the current user, thereby expanding a range of friend recommendation and improving accuracy of the friend recommendation.

In an example, after step 402 of the user association method that is performed by the first application server according to the embodiments of the present invention, the method further includes: storing the associated activity information of the first user and the second user, to facilitate use of the associated activity information in a subsequent step. After step 501 of the user association method that is performed by the first terminal according to the embodiments of the present invention, the method further includes: storing the associated activity information of the first user and the second user, to facilitate use of the associated activity information in a subsequent step.

In an example, the associated activity information further includes user source information of the second user. The user association method that is performed by the first application server according to the embodiments of the present invention further includes: sending, by the first application server, the user source information of the second user to the first terminal, so that the first terminal displays the user source information of the second user on the friend recommendation screen of the first application. The user association method that is performed by the first terminal according to the embodiments of the present invention further includes: displaying, by the first terminal, the user source information on the friend recommendation screen of the first application.

The user source information may indicate the second application that causes the first user and the second user to perform associated activities, or may indicate information that enables the first user to identify a place at which the first user and the second user perform the associated activities, such as a game, a forum, a game type, or the like that causes the first user and the second user to perform associated activities in the second application. Therefore, the user association method according to the embodiments of the present invention not only expands a range of friend recommendation and improves accuracy of the friend recommendation, but also can enable the first user to know a source of the second user, thereby making it convenient for the user to manage a potential friend.

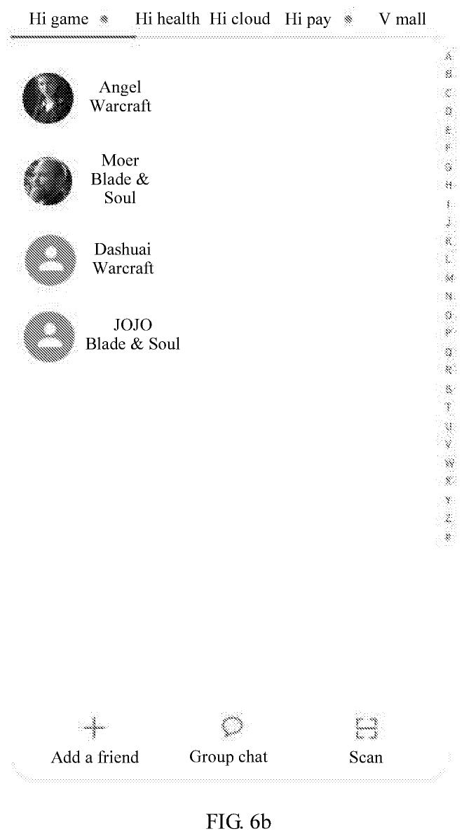

As shown in FIG. 7, by way of example and not limitation, the second application may be a game application, a user name of the second user may be Angel, and the first user and Angel may play Warcraft together in a corresponding time period and have a same ranking, in other words, the first user and Angel perform associated activities in the Warcraft game. In this case, user source information of Angel is Warcraft, and the first application server may send the user source information of Angel, namely, Warcraft to the first terminal, so that the first terminal displays the user source information of Angel on the friend recommendation screen of the first application. In this embodiment of the present invention, Warcraft may be an independent application, or may be a game in a game application.

In an example, the user association method that is performed by the first application server in the embodiments of the present invention further includes: receiving, by the first application server, an operation instruction of the first user that is sent by the first terminal and that is used for adding the second user to a user list; creating, by the first application server, at least one user group in the user list based on the user source information; and adding, by the first application server, second users belonging to same user source information into a same user group. In another example, the first terminal may add second users belonging to same user source information into a same user group. The user association method that is performed by the first terminal according to the embodiments of the present invention further includes: receiving, by the first terminal from the first user, an operation instruction for adding the second user to a user list; creating, by the first terminal, at least one user group in the user list based on the user source information; and adding, by the first terminal, second users belonging to same user source information into a same user group. When the first user sees the user information of the second user on the friend recommendation screen of the first application, the first user may choose to add the second user as a formal friend, to be specific, send an operation instruction for adding the second user to the user list. The first terminal receives the operation instruction and sends the operation instruction to the first application server. Alternatively, the first terminal receives the operation instruction and performs a subsequent step according to the operation instruction. The user list may be a friend list of the user. The first application server receives an operation instruction of the first user that is sent by the first terminal and that is used for adding the second user to the user list. If the user list does not have a user group to which the user source information of the second user belongs when the first user adds the second user as a friend, the first application server or the first terminal may create at least one user group based on the source information of the second user when the first user adds the second user as a friend. By way of example and not limitation, the first user may add the second user whose user source information is Warcraft, and if the user list does not have a user group to which Warcraft belongs or is related, the first application server or the first terminal may create a user group named “Warcraft”; or may create a user group based on a category to which the user source information belongs. For example, the user source information is still Warcraft. Because Warcraft is a game, a user group named “game” is created.

The first application server or the first terminal may add second users belonging to same user source information into a same user group. In an example, if source information of two or more second users is Warcraft, the first application server or the first terminal may add the two or more second users into a user group “Warcraft”, or add the two or more second users into a user group “game”.

In an example, in the user association method according to the embodiments of the present invention, the associated activity information further includes attribute information of associated activities performed by the users, and the attribute information may include occurrence time, frequency, and the like of the associated activities. In the user association method that is performed by the first application server according to the embodiments of the present invention, before the sending, by the first application server, the user information of the second user to the first terminal, the method further includes: sorting, by the first application server, display priorities for the second user based on the attribute information; and sending, by the first application server, a display priority sorting result of the second user to the first terminal, so that the first terminal displays the display priority sorting result of the second user on the friend recommendation screen of the first application. In the user association method that is performed by the first terminal according to the embodiments of the present invention, before the displaying, by the first terminal, the user information of the second user on a friend recommendation screen of a first application, the method further includes: sorting, by the first terminal, display priorities for the second user based on the attribute information; and displaying, by the first terminal, a display priority sorting result of the second user on the friend recommendation screen of the first application.

Specifically, the first application server or the first terminal may sort display priorities for the second user based on attribute information including a time sequence, frequency, or the like of the associated activities performed by the first user and the second user, and a display priority of a second user corresponding to an associated activity whose occurrence time is closer to current time and that occurs more frequently ranks higher. The first application server or the first terminal may sort display priorities for the second user based on attribute information including only a time sequence of the associated activities performed by the first user and the second user, and a display priority of a second user corresponding to an associated activity whose occurrence time is closer to current time ranks higher. The first application server or the first terminal may sort display priorities for the second user based on attribute information including only frequency of the associated activities performed by the first user and the second user, and a display priority of a second user corresponding to an associated activity that occurs more frequently ranks higher.

After performing display priority sorting, the first application server sends the sorting result to the first terminal, and the first terminal displays the second user on the friend recommendation screen of the first application according to the sorting result; or the first terminal displays the second user on the friend recommendation screen of the first application according to the sorting result.

In an example, as shown in FIG. 7, the second user may include Angel and Moer, the first user and Moer may play a game Blade & Soul together, and associated activity information is generated. Subsequently, the first user and Angel may play a game Warcraft together, and associated activity information is generated. When analyzing the associated activity information, the first application server or the first terminal also obtains attribute information of the associated activity information. The attribute information may be time periods in which the first user plays Warcraft with Angel and Moer respectively. Then, display priority sorting is performed on Angel and Moer based on occurrence time of the associated activity information. People may be usually more interested in a person whom they met recently, and more intended to make friends with the person. Therefore, the first application server or the first terminal may rank a display priority of Angel higher. The first application server sends a display priority sorting result of Angel and Moer to the first terminal. As shown in FIG. 7a, the first terminal displays Angel and Moer on the friend recommendation screen of the first application according to the display priority sorting result. Alternatively, the first terminal displays Angel and Moer on the friend recommendation screen of the first application according to the display priority sorting result obtained through processing by the first terminal.

In addition to the occurrence time of the associated activities, people are also interested in a person whose associated activities with the people occur more frequently. Therefore, the first application server or the first terminal may also rank higher a display priority of a second user corresponding to an associated activity that occurs more frequently. Further, the display priority of the second user on the friend recommendation screen of the first application ranks higher.

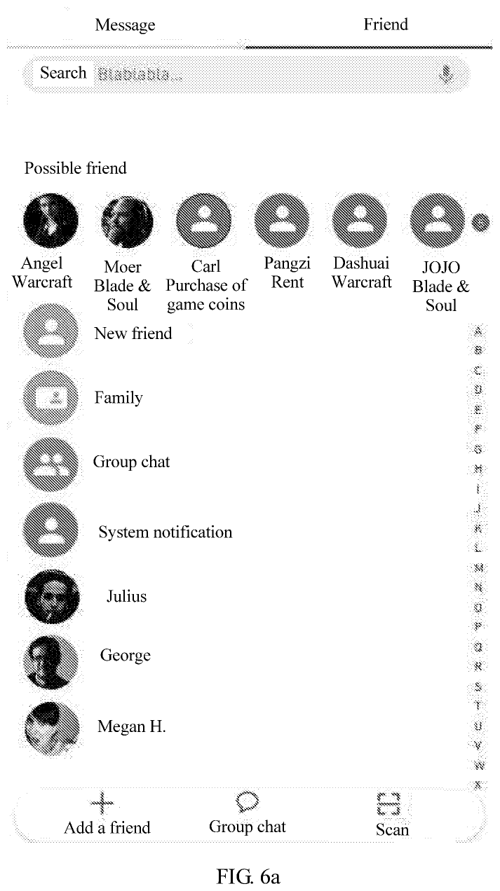

In an example, as shown in FIG. 6b, the user association method according to the embodiments of the present invention provide further includes: creating, by the first application server or the first terminal, a second-user source category tab on the friend recommendation screen of the first application based on the user source information of the second user. For example, if the user source information of the second user is Warcraft, and a category thereof is a game, the first application server or the first terminal may create a game tab. The first application server sends the second-user source category tab to the first terminal, so that the first terminal adds second users belonging to a same user source category into a same second-user source category tab; or the first terminal adds second users belonging into a same user source category to a same second-user source category tab. For example, source information of a second user is Blade & Soul, and source information of another second user is Warcraft, and both belong to a category of game. In this case, the first terminal or the first terminal may add the two second users into the game tab for display.

In an example, the user association method that is performed by the first application server according to the embodiments of the present invention further includes: receiving, by the first application server, an operation instruction of the first user that is sent by the first terminal and that is used for obtaining a second-user source category tab; creating, by the first application server, a second-user source category tab based on the user source information of the second user; and sending the second-user source category tab to the first terminal, so that the first terminal adds second users belonging to a same user source category into a same second-user source category tab. The user association method that is performed by the first terminal according to the embodiments of the present invention further includes: receiving, by the first terminal from the first user, an operation instruction for obtaining a second-user source category tab; creating, by the first terminal, a second-user source category tab based on the user source information of the second user; and adding, by the first terminal, second users belonging to a same user source category into a same second-user source category tab.

Specifically, the source information includes second application information, a tab may be created based on a single second application, and second users from a same second application are added into a same second application category tab. Alternatively, serialized categorization may be performed. To be specific, a tab is created based on a category of the second application, and second users from a same category of second application are added into the category tab. For example, a second application is Warcraft, another second application is Blade & Soul, and both second applications are game applications. In this case, a game category tab may be created, and then second users from game applications are added into the game category tab. Whether to create a single second application category tab or a serialized category tab may be determined based on a quantity of second users.

An effect of the example is shown in FIG. 6a and FIG. 6b. A friend recommendation screen of the first application displays only information about the second user. The first user may tap or click a blank on the friend recommendation screen, to send an operation instruction for obtaining a second-user source category; then may create a second-application source category tab by using the first application server and send the tab to the first terminal, to display the tab on the friend recommendation screen of the first application, and display, in the tab, a second user whose user source information belongs to the tab; or may create a second-user source category tab by using a terminal on which the first application is located, display the tab on the friend recommendation screen of the first application, and display, in the tab, a second user whose user source information belongs to the tab.

In an example, the user association method that is performed by the first application server according to the embodiments of the present invention further includes: sorting, by the first application server, display priorities for the second-user source category tab based on a quantity of second users included in the second-user source category tab; and sending, by the first application server, a display priority sorting result of the second-user source category tab to the first terminal, so that the first terminal displays the display priority sorting result of the second-user source category tab on the friend recommendation screen of the first application. The user association method that is performed by the first terminal according to the embodiments of the present invention further includes: sorting, by the first terminal, display priorities for the second-user source category tab based on a quantity of second users included in the second-user source category tab; and displaying, by the first terminal, a display priority sorting result of the second-user source category tab on the friend recommendation screen of the first application.

In the example, a display effect on the first application is shown in FIG. 7. A game tab with a largest quantity of second users is displayed on top, a health tab with a second largest quantity of second users is displayed second, and a cloud service tab, a payment tab, and a shopping mall tab are sequentially displayed based on quantities of included second users.

In an example, the user association method that is performed by the first application server according to the embodiments of the present invention further includes: receiving, by the first application server, information about an operation instruction of the first user that is sent by the first terminal and that is used for creating a customized tab; creating, by the first application server based on the information about the operation instruction for creating a customized tab, a tab customized by the first user; and sending, by the first application server, the customized tab to the first terminal, so that the first terminal adds a second user that meets a customized condition of the first user into the customized tab. The user association method that is performed by the first terminal according to the embodiments of the present invention further includes: receiving, by the first terminal from the first user, information about an operation instruction for creating a customized tab; creating, by the first terminal based on the information about the operation instruction for creating a customized tab, a tab customized by the first user; and adding, by the first terminal, a second user that meets a customized condition of the first user into the customized tab.

The example on the first application exerts an effect that the first user may customize a tab in the first application, and add the second user that meets the customized condition into the tab customized by the first user for display. In an example, the user may customize a real friend tab. If the first application server or the first terminal stores a telephone number of the second user, and the associated activity information that are of the first user and the second user and that are in the second application also includes the telephone number of the second user, it indicates that the first user and the second user may meet offline, have a call, or the like. This implies that the first user and the second user are already real friends offline. The first terminal or the first terminal may display the user information of the second user in the real friend tab customized by the user.

In an example, the user association method that is performed by the first application server according to the embodiments of the present invention further includes: receiving, by the first application server, information about an operation instruction of the first user that is sent by the first terminal and that is used for creating a customized friend group; creating, by the first application server, a customized friend group in the user list based on the information about the operation instruction for creating a friend group; and sending, by the first application server, the customized friend group to the first terminal, so that the first terminal adds a second user that meets a customized condition of the first user into the customized friend group. The user association method that is performed by the first terminal according to the embodiments of the present invention further includes: receiving, by the first terminal from the first user, information about an operation instruction for creating a customized friend group; creating, by the first terminal, a customized friend group in the user list based on the information about the operation instruction for creating a friend group; and adding, by the first terminal, a second user that meets a customized condition of the first user into the customized friend group.

The example on the first application exerts an effect that the first user may customize a friend group in the user list of the first application, and add the second user that meets the customized condition into the customized friend group of the first user for display. In an example, the user may customize a real friend group. If the first application server or the first terminal stores a telephone number of the second user, and the associated activity information that are of the first user and the second user and that are in the second application also includes the telephone number of the second user, it indicates that the first user and the second user may meet offline, have a call, or the like. This implies that the first user and the second user are already real friends offline. The first terminal may display the user information of the second user in the real friend group customized by the user.

In the user association method provided in this embodiment of the present invention, associated activity information of a current user of the first application and another user in another application is analyzed, to recommend the another user of interest to the current user as a potential friend to the current user, thereby expanding a range of friend recommendation and improving accuracy of the friend recommendation. In addition, the user association method according to this embodiment of the present invention can further display a source of a recommended friend, thereby making it convenient for the user to manage the friend.

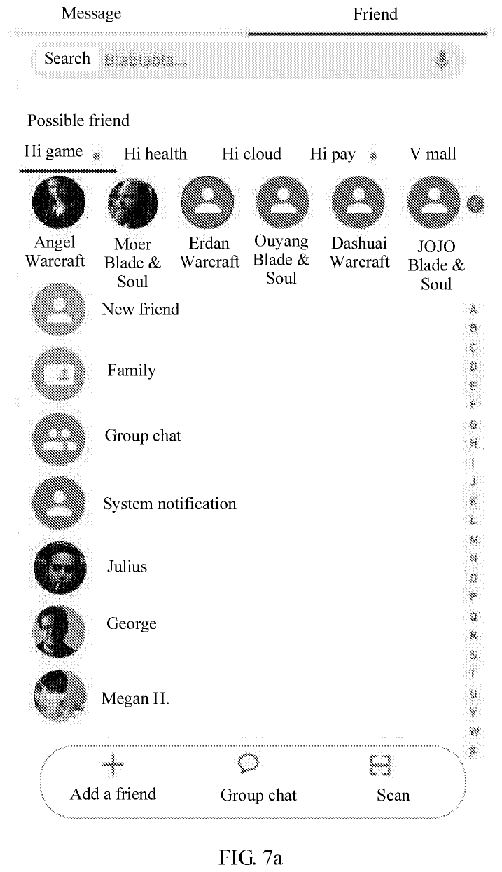

Correspondingly, an embodiment of the present invention further provides a server, to implement the user association method that is performed by the first application server according to the embodiments of the present invention. As shown in FIG. 8, the server includes a receiving unit 801, an obtaining unit 802, a processing unit 803, and a sending unit 804.

The receiving unit 801 is configured to receive an account of a first user that is sent by a first terminal.

The obtaining unit 802 is configured to obtain associated activity information of the first user and a second user from a second application server based on the account of the first user, where the associated activity information includes user information of the second user.

The processing unit 803 is configured to determine, based on the associated activity information, whether the first user and the second user are associated users.

The sending unit 804 is further configured to send the user information of the second user to the first terminal if the first user and the second user are associated users, so that the first terminal displays the user information of the second user on a friend recommendation screen of a first application.

In an example, the server further includes a storage unit 805, configured to store the associated activity information of the first user and the second user, to facilitate use of the associated activity information in a subsequent step.

In an example, the associated activity information further includes user source information of the second user. The sending unit 804 is further configured to send the user source information of the second user to the first terminal, so that the first terminal displays the user source information of the second user on the friend recommendation screen of the first application.

In an example, the receiving unit 801 is further configured to receive an operation instruction of the first user that is sent by the first terminal and that is used for adding the second user to a user list. The processing unit 803 is further configured to: create at least one user group in the user list based on the user source information; and is further configured to add, by a user, second users belonging to same user source information into a same user group.

In an example, the associated activity information further includes attribute information of associated activities performed by the users. The processing unit 803 is further configured to sort display priorities for the second user based on the attribute information. The sending unit 804 is further configured to send a display priority sorting result of the second user to the first terminal, so that the first terminal displays the display priority sorting result of the second user on the friend recommendation screen of the first application.

In an example, the processing unit 803 is further configured to create a second-user source category tab on the friend recommendation screen of the first application based on the user source information of the second user. The sending unit 804 is further configured to send the second-user source category tab to the first terminal, so that the first terminal adds second users belonging to a same user source category into a same second-user source category tab.

In an example, the processing unit 803 is further configured to sort display priorities for the second-user source category tab based on a quantity of second users included in the second-user source category tab. The sending unit 804 is further configured to send a display priority sorting result of the second-user source category tab to the first terminal, so that the first terminal displays the display priority sorting result of the second-user source category tab on the friend recommendation screen of the first application.

In an example, the receiving unit 801 is further configured to receive information about an operation instruction of the first user that is sent by the first terminal and that is used for creating a customized tab. The processing unit 803 is further configured to create, based on the information about the operation instruction for creating a customized tab, a tab customized by the first user. The sending unit 804 is further configured to send the tab customized by the first user to the first terminal, so that the first terminal adds a second user that meets a customized condition of the first user into the tab customized by the first user.

In an example, the receiving unit 801 is further configured to receive information about an operation instruction of the first user that is sent by the first terminal and that is used for creating a customized friend group. The processing unit 803 is further configured to create a customized friend group in the user list based on the information about the operation instruction for creating a customized friend group. The sending unit 804 is further configured to send the customized friend group to the first terminal, so that the first terminal adds a second user that meets a customized condition of the first user into the customized friend group.

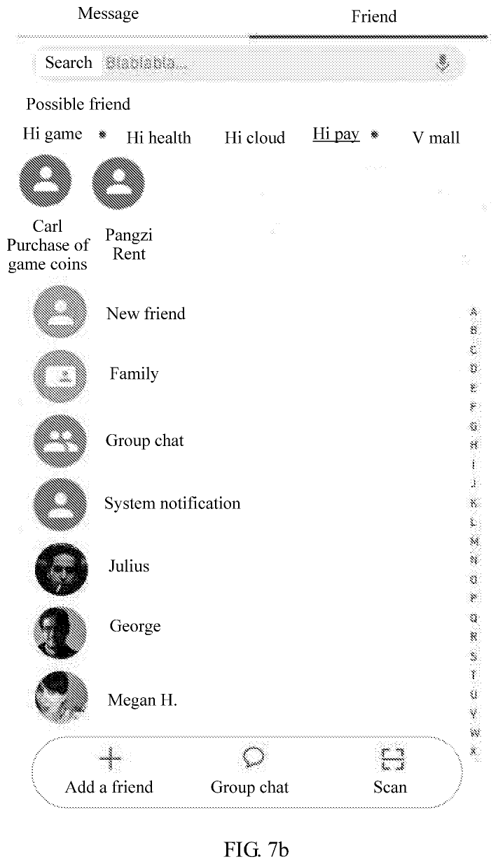

An embodiment of the present invention further provides a server, to implement the user association method that is performed by the first application server according to the embodiments of the present invention. As shown in FIG. 9, the server may include an interface circuit 901, a processor 902, a memory 903, a power supply 904, and the like.

The interface circuit 901 is configured to: receive an account of a first user that is sent by a first terminal, and obtain associated activity information of the first user and a second user from a second application server based on the account of the first user, where the associated activity information includes user information of the second user.

The processor 902 is configured to determine, based on the associated activity information, whether the first user and the second user are associated users.

The interface circuit 901 is further configured to send the user information of the second user to the first terminal if the first user and the second user are associated users, so that the first terminal displays the user information of the second user on a friend recommendation screen of a first application.

In an example, the memory 903 is configured to store the associated activity information corresponding to the second user that is an associated user of the first user, to use the associated activity information in a subsequent step.

In an example, the associated activity information further includes user source information of the second user. The interface circuit 901 is further configured to send the user source information to the first terminal, so that the first terminal displays the user source information on the friend recommendation screen of the first application.

In an example, the interface circuit 901 is further configured to receive an operation instruction of the first user that is sent by the first terminal and that is used for adding the second user to a user list. The processor 902 is further configured to: create at least one user group in the user list based on the user source information; and is further configured to add, by a user, second users belonging to same user source information into a same user group.

In an example, the associated activity information further includes attribute information of associated activities performed by the users. The processor 902 is further configured to sort display priorities for the second user based on the attribute information. The interface circuit 901 is further configured to send a display priority sorting result of the second user to the first terminal, so that the first terminal displays the display priority sorting result of the second user on the friend recommendation screen of the first application.

In an example, the processor 902 is further configured to create a second-user source category tab on the friend recommendation screen of the first application based on the user source information of the second user. The interface circuit 901 is further configured to send the second-user source category tab to the first terminal, so that the first terminal adds second users belonging to a same user source category into a same second-user source category tab.

In an example, the processor 902 is further configured to sort display priorities for the second-user source category tab based on a quantity of second users included in the second-user source category tab. The interface circuit 901 is further configured to send a display priority sorting result of the second-user source category tab to the first terminal, so that the first terminal displays the display priority sorting result of the second-user source category tab on the friend recommendation screen of the first application.

In an example, the interface circuit 901 is further configured to receive information about an operation instruction of the first user that is sent by the first terminal and that is used for creating a customized tab. The processor 902 is further configured to create, based on the information about the operation instruction for creating a customized tab, a tab customized by the first user. The interface circuit 901 is further configured to send the tab customized by the first user to the first terminal, so that the first terminal adds a second user that meets a customized condition of the first user into the tab customized by the first user.

In an example, the interface circuit 901 is further configured to receive information about an operation instruction of the first user that is sent by the first terminal and that is used for creating a customized friend group. The processor 902 is further configured to create a customized friend group in the user list based on the information about the operation instruction for creating a customized friend group. The interface circuit 901 is further configured to send the customized friend group to the first terminal, so that the first terminal adds a second user that meets a customized condition of the first user into the customized friend group.

The server according to this embodiment of the present invention may be used to analyze associated activity information of a current user of the first application and another user in another application, to recommend the another user of interest to the current user as a potential friend to the current user, thereby expanding a range of friend recommendation and improving accuracy of the friend recommendation. In addition, the user association method according to this embodiment of the present invention can further display a source of a recommended friend, thereby making it convenient for the user to manage the friend.

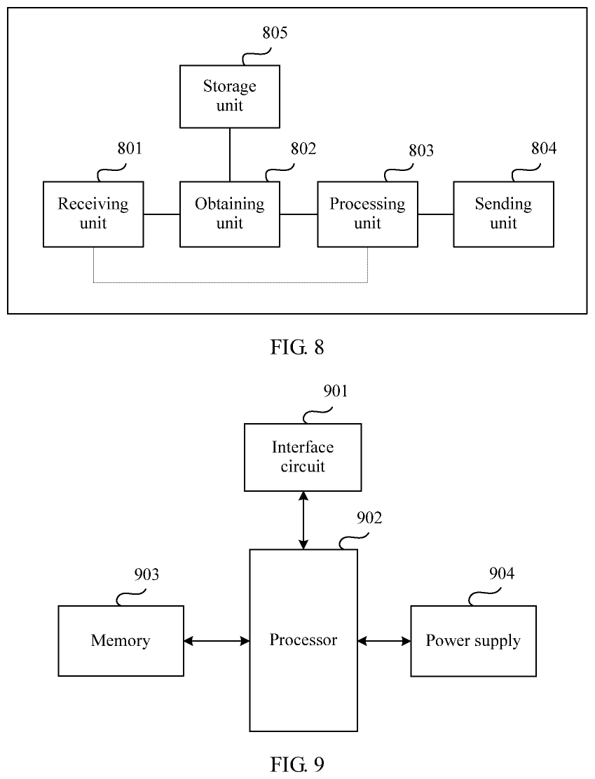

An embodiment of the present invention further provides a user association terminal, to implement the user association method that is performed by a terminal on which the first application is located according to the embodiments of the present invention. As shown in FIG. 10, the terminal includes: an obtaining unit 1001, configured to obtain, based on an account of a first user, associated activity information of the first user and a second user from a terminal on which a second application is located, where the associated activity information includes user information of the second user; a processing unit 1002, configured to determine, based on the associated activity information, whether the first user and the second user are associated users; and a display unit 1003, configured to display the user information of the second user on a friend recommendation screen of the first user if the first user and the second user are associated users.

In an example, the terminal further includes a storage unit 1004, configured to store the associated activity information of the first user and the second user, to facilitate use of the associated activity information in a subsequent step.

In an example, for other preferred functions of the terminal, refer to the descriptions of the user association method that is performed by the terminal on which the first application is located and the descriptions of the first application server function unit. Details are not described herein again.

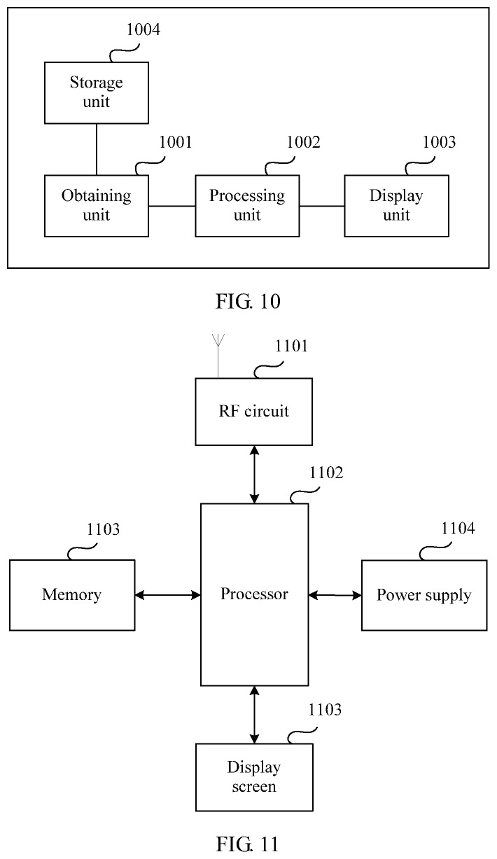

An embodiment of the present invention further provides a terminal, to implement the user association method that is performed by the first terminal is located according to the embodiments of the present invention. As shown in FIG. 11, the terminal may include an RF circuit 1101, a processor 1102, a memory 1103, a power supply 1104, a display screen 1105, and the like. The RF circuit 1101 is configured to obtain, based on an account of a first user, associated activity information of the first user and a second user from a second terminal, where the associated activity information includes user information of the second user. The processor 1102 is configured to determine, based on the associated activity information, whether the first user and the second user are associated users. The display screen 1105 is configured to display the user information of the second user on a friend recommendation screen of the first user if the first user and the second user are associated users.

For preferred functions of functional units of the terminal, refer to the descriptions of the user association method that is performed by the first terminal and a virtual functional unit of the terminal. Details are not described herein again.

The terminal according to this embodiment of the present invention may be used to analyze associated activity information of a current user of the first application and another user in another application, to recommend the another user of interest to the current user as a potential friend to the current user, thereby expanding a range of friend recommendation and improving accuracy of the friend recommendation. In addition, the user association method according to this embodiment of the present invention can further display a source of a recommended friend, thereby making it convenient for the user to manage the friend.

A person skilled in the art may be further aware that, in combination with the examples described in the embodiments disclosed in this specification, units and algorithm steps may be implemented by electronic hardware, computer software, or a combination of the two. To clearly describe interchangeability between the hardware and the software, compositions and steps of each example have generally been described in the foregoing specification based on functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

The steps in the method or algorithm described in the embodiments disclosed in this specification may be implemented by hardware, software module executed by the processor, or combination of hardware and software. The software module may reside in a random-access memory (RAM), a memory, a read-only memory (ROM), an electrically programmable ROM, an electrically erasable programmable ROM, a register, a hard disk, a removable disk, a CD-ROM, or any other form of storage medium known in the art.

In the foregoing specific implementations, the objective, technical solutions, and benefits of the present invention are further described in detail. It should be understood that the foregoing descriptions are merely specific implementations of the present invention, but are not intended to limit the protection scope of the present invention. Any modification, equivalent replacement, or improvement made without departing from the principle of the present invention should fall within the protection scope of the present invention.

1. A device, comprising:
a memory configured to store one or more programs, wherein the one or more programs comprise instructions; and
one or more processors coupled to the memory, wherein when executed by the one or more processors, the instructions cause the device to be configured to:
receive an account of a first user from a first terminal;
obtain associated activity information of the first user and a second user from an application server based on the account of the first user, wherein the associated activity information comprises user information of the second user;
determine, based on the associated activity information, whether the first user and the second user are associated users; and
send the user information to the first terminal to display the user information on a screen of a first application when the first user and the second user are associated users.

2. The device of claim 1, wherein the associated activity information further comprises user source information of the second user, and wherein when executed by the one or more processors, the instructions further cause the device to be configured to send the user source information to the first terminal to display the user source information on the screen of the first application.

3. The device of claim 2, wherein when executed by the one or more processors, the instructions further cause the device to be configured to:
receive, from the first terminal, an operation instruction of the first user for adding the second user to a user list;
create at least one user group in the user list based on the user source information; and
add second users belonging to a same user source information into a same user group.

4. The device of claim 1, wherein the associated activity information further comprises attribute information of associated activities of the first user and the second user, and wherein before sending the user information to the first terminal, when executed by the one or more processors, the instructions further cause the device to be configured to:
sort display priorities for the second user based on the attribute information; and
send a display priority sorting result of the second user to the first terminal to display the display priority sorting result of the second user on the screen of the first application.

5. The device of claim 2, wherein when executed by the one or more processors, the instructions further cause the device to be configured to:
receive, from the first terminal, an operation instruction for obtaining a second-user source category tab;
create the second-user source category tab on the screen of the first application based on the user source information; and
send the second-user source category tab to the first terminal to add second users belonging to a same user source category into a same second-user source category tab.

6. The device of claim 5, wherein when executed by the one or more processors, the instructions further cause the device to be configured to:
sort priority display for the second-user source category tab based on a quantity of the second users comprised in the second-user source category tab; and
send a priority display sorting result of the second-user source category tab to the first terminal to display the priority display sorting result of the second-user source category tab on the screen of the first application.

7. The device of claim 1, wherein when executed by the one or more processors, the instructions further cause the device to be configured to:
receive, from the first terminal, information about an operation instruction of the first user for creating a customized tab;
create, on the information about the operation instruction for creating the customized tab, the customized tab; and
send the customized tab to the first terminal to add a third user meeting a customized condition of the first user into the customized tab.

8. The device of claim 3, wherein when executed by the one or more processors, the instructions further cause the device to be configured to:
receive, from the first terminal, information about an operation instruction of the first user for creating a customized friend group;
create the customized friend group in the user list based on the information about the operation instruction for creating the customized friend group; and
send the customized friend group to the first terminal to add a third user meeting a customized condition of the first user into the customized friend group.

9. A device, comprising:
a memory configured to store one or more programs, wherein the one or more programs comprise instructions; and
one or more processors coupled to the memory, wherein when executed by the one or more processors, the instructions cause the device to be configured to:
receive an account of a first user from a first terminal;
obtain associated activity information of the first user and a second user from an application server based on the account of the first user, wherein the associated activity information comprises user information of the second user;
determine, based on the associated activity information, whether the first user and the second user are associated users; and
send the user information to the first terminal to display the user information on a screen of a first application when the first user and the second user are associated users.

10. (canceled)

11. A device, comprising:
a memory configured to store one or more programs, wherein the one or more programs comprise instructions; and
one or more processors coupled to the memory, wherein when executed by the one or more processors, the instructions cause the device to be configured to:
obtain, based on an account of a first user, associated activity information of the first user and a second user from a terminal, wherein the associated activity information comprises user information of the second user;
determine, based on the associated activity information, whether the first user and the second user are associated users; and
display the user information of the second user on a friend recommendation screen of a first application when the first user and the second user are associated users.

12. The device of claim 11, wherein the associated activity information further comprises user source information of the second user, wherein when executed by the one or more processors, the instructions further cause the device to be configured to display the user source information on the friend recommendation screen of the first application.

13. The device of claim 12, wherein when executed by the one or more processors, the instructions further cause the device to be configured to:
receive, from the first user, an operation instruction for adding the second user to a user list;
create at least one user group in the user list based on the user source information; and
add second users belonging to a same user source information into a same user group.

14. The device of claim 11, wherein the associated activity information further comprises attribute information of associated activities of users, and wherein before displaying the user information on the friend recommendation screen of the first application, when executed by the one or more processors, the instructions further cause the device to be configured to:
sort display priorities for the second user based on the attribute information; and
display a display priority sorting result of the second user on the friend recommendation screen of the first application.

15. The device of claim 12, wherein when executed by the one or more processors, the instructions further cause the device to be configured to:
create a second-user source category tab on the friend recommendation screen of the first application based on the user source information; and
add second users belonging to a same user source category into a same second-user source category tab.

16. The device of claim 15, wherein when executed by the one or more processors, the instructions further cause the device to be configured to:
sort display priorities for the second-user source category tab based on a quantity of the second users comprised in the second-user source category tab; and
display a display priority sorting result of the second-user source category tab on the friend recommendation screen of the first application.

17. The device of claim 15, wherein when executed by the one or more processors, the instructions further cause the device to be configured to:
receive, from the first user, information about an operation instruction for creating a customized tab;
create, based on the information about the operation instruction for creating the customized tab, the customized tab; and
add a third user meeting a customized condition of the first user into the customized tab.

18. The device of claim 13, wherein when executed by the one or more processors, the instructions further cause the device to be configured to:
receive, from the first user, information about an operation instruction for creating a customized friend group;
create the customized friend group in the user list based on the information about the operation instruction for creating the customized friend group; and
add a third user meeting a customized condition of the first user into the customized friend group.

19. The device of claim 13, wherein the device and the terminal are a same terminal.

20.-21. (canceled)
